(19) United States
(12) Patent Application Publication
(10) Pub. No.: US 2015/0189720 A1
(43) Pub. Date: Jul. 2, 2015

(54) HOLIDAY LIGHTS DOCKING STATION

(71) Applicant: WAYNE WALKER, Fayetteville, AR (US)

(72) Inventor: WAYNE WALKER, Fayetteville, AR (US)

(21) Appl. No.: 14/145,569

(22) Filed: Dec. 31, 2013

(51) Int. Cl. H05B 37/02

(52) U.S. Cl. CPC H05B 37/0227

(57) ABSTRACT

The present invention pertains to a customizable electronic, mobile or other device connection having a dock, plug in, or other communication (including wireless) that communicates between devices which generate music or other type of communication, or that has its own storage capacity for such music or other communication; such device thereafter signaling to a light source, such as a holiday light strand, certain phases, impulses, signals to such lights to create a visual effect having causal connection to light patterns with the music or other audible or sub-audible communication.

### CROSS REFERENCES

Provisional patent application Ser. No. 61/747,476; filed Dec. 31, 2012

### GOVERNMENT RIGHTS

None.

### FIELD OF THE INVENTION

The present invention pertains to a customizable electronic, mobile or other device connection having a dock, plug in, or other communication (including wireless) that communicates between devices which generate music or other type of communication, or that has its own storage capacity for such music or other communication; such device thereafter signaling to a light source, such as a holiday light strand, certain phases, impulses, signals to such lights to create a visual effect having causal connection to light patterns with the music or other audible or sub-audible communication.

### BACKGROUND OF THE INVENTION

The present invention pertains to a customizable electronic device having a plug in, or other communication including wireless such as Bluetooth® that communicates between devices which generate music, or that has its own storage capacity for such music, such device thereafter signaling or controlling a light source, such as a holiday light strand, certain phases, impulses, signals to such lights to create a visual effect having causal connection to light patterns with the music or other audible or sub-audible communication.

Holiday lights come in all shapes and sizes and typically have varying color, light intensity, flashing display, blinking, or alternating light patterns. Typically, blinking lights do so because the wiring has an interruptible electricity pathway such as a light bulb that is designed to cause flickering in the other light bulbs run in a series. It is generally the bulb closest to the end of the string that plugs into an electrical outlet. Removing this bulb and replacing it with a blinking bulb will cause the blinking or flickering to occupy the entire line. This flickering or blinking light design is very basic to holiday lighting.

Music typically accompanies festive events. It has been a long felt commercial need to play music and have holiday lighting flicker or blink in rhyme with the music in order to enhance the viewer's experience. Complex electronics has been one answer. Homeowners who seek to create a link between music pulses and light show displays featuring many strands and bulbs do so with the use of complex light controllers. Multiple light strands are hooked into these controllers having channels that allow the electric source have an intermittent supply of electricity as controlled by the controller algorithms. These controllers can be programmed whereby multiple channels are used to help animate the lighting in response to programming and input sequences. Sophisticated computer software programs are available to establish a link between the controller and rhythmic pulses including music inputs. Homeowners and commercial businesses who seek to pair the light show with the music being played have a substantial investment into lights, light controller boards driving various data networks, code sets as set by personal computers, and channels to independently control many different lighting channels. Each strand of lights is preferentially networked into the controllers. Working together, these many controllers, channels, and software components allow homeowners to network lights to music to create an orchestrated light show using multiple holiday light strands. Tracks of music are programmed to link with the controllers and create a light show that appears to be connected to the beat and rhythm of the music selection. Vendors offer music pre-programmed to load into the software platforms that run the light controllers and channels.

The invention is for those people who do not wish to invest heavily into complex controllers having many channels and software requirements in order to have a holiday light show. The invention is for those people who do not want to spend time pre-programming music selections with complex controllers in order to achieve light and music integration. The invention is for those people who want to plug in a single, double, or triple strand of holiday lights, or sufficient quantity to illuminate a wreath or decorative tree using a self-contained unit having input (wireless or wired), speaker, programmable circuitry, and AC input and output components. The ease and commercial appeal for a low-cost, pre-programmed unit is a substantial improvement in the marketplace for consumers.

### SUMMARY OF THE INVENTION

The present invention is a customizable yet elegantly simple self contained electronic device having one or more data inputs from which to receive any variety of music, the device having logic and programming to control and communicate with one or more holiday lighting strands, thereby causing upon those strands electrical signals that compel a light blinking or flashing in a rhythmic pattern substantially consistent with the rhythm of the musical input.

### DESCRIPTION OF THE PREFERRED EMBODIMENT

A Controller having input/output ports, peripheral connections, bus and power connectors, heat sinks and mounting points, supporting chipset for CPU, bus and external components, BIOS, memory sockets for RAM, ROM and cache, and interconnecting circuitry.

An Auxiliary Port or other standard communications port AUX is an asynchronous serial port with an interface that allows the auxiliary input of audio signals that permits the controller board to receive data, connected to the controller. The auxiliary port may comprise a traditional AUX port or may comprise other connectors including but not limited to connectors specific to certain phones and audio devices such as 18, 20, 22, 24, 26, 30, 40, or 42-pin dock connectors.

An Audio Speaker is connected to the controller.

A Wireless Receiver module having integrated EEPROM, configurable operating modes and parameters, interfacing with the controller. The wireless receiver module may include wireless Bluetooth® technology, or another technology that facilitates data communication between two or more devices wirelessly.

A Power Supply providing electricity to the controller and other components, including Bluetooth receiver module.

A Power Switch enabling a user to turn the unit on and off.

A Volume Switch enabling a user to adjust the volume of the speaker.

An AC Output Unit to supply electrical connection to holiday light strands, such AC output unit being modulated synchronously to the music rhythm by the controller or other related components.

A Housing Unit to encapsulate the components, thereby making the product commercially appealing and relatively small in size.

A Mode Switch enabling a user to preferentially modify the pre-programmed light synchronous rates from faster to slower to synchronously accompanying the rhythm of the music as input to the controller through either the wireless receiver module or the auxiliary port.

The preferred embodiment comprises a housing unit having an AC input providing power to a controller and a wireless receiver module. The wireless receiver module may be integrated into the controller or it may be a separate logic board that is otherwise connected to the controller to provide proper data transfer of the data received wirelessly from a device such as a phone having wireless data transmission capability or other device such as a tablet or computer. The controller is programmed to collect, process and analyze such data comprising the sound signal. The housing also provides structure to mount the auxiliary port, which communicates with the controller to provide a direct source of the sound signal. The controller is programmed to analyze the sound signal and preferentially set a modulated output value to drive the AC output unit. The controller is programmed to permit and facilitate the sound signal to pass to the speaker, which then broadcasts the sound signal to the listener. The AC output unit receives the modulated output value and delivers sufficient voltage to the holiday lights plugged into the AC output unit to create light in a flickering or alternating pattern. The modulated output value as created by the controller and related components will direct sufficient voltage to the AC output unit so as to create brightness variations in the holiday lighting strand(s).

It is contemplated that reasonable modifications to the present embodiment are also included in this disclosure, such as the use of multiple AC output units to better supply a multitude of holiday light strands.

I claim:

1. A programmable electronic device for use with one or more holiday light strands comprising:
a controller having ports, peripheral connections, bus and power connectors, heat sinks and mounting points, supporting chipset for CPU, bus and external components, BIOS, memory sockets for RAM, ROM and cache, and interconnecting circuitry;
an asynchronous serial port for the auxiliary input of audio signals that permits the controller to receive data, which is connected to the controller;
an audio speaker connected to the controller.
a wireless receiver module having integrated EEPROM, configurable operating modes and parameters, interfacing with the controller;
a power supply providing electricity to the controller and other components;
a power switch;
a volume switch;
an AC output unit to supply electrical connection to holiday light strands, such AC output unit being modulated synchronously to the music rhythm by the controller;
a housing unit to encapsulate the foregoing.

2. A programmable electronic device for use with one or more holiday light strands comprising:
a controller having ports, peripheral connections, bus and power connectors, heat sinks and mounting points, supporting chipset for CPU, bus and external components, BIOS, memory sockets for RAM, ROM and cache, and interconnecting circuitry;
a connector specific to certain phones for the input of audio signals that permits the controller to receive data, which is connected to the controller;
an audio speaker connected to the controller.
a wireless receiver module having integrated EEPROM, configurable operating modes and parameters, interfacing with the controller;
a power supply providing electricity to the controller and other components;
a power switch;
a volume switch;
an AC output unit to supply electrical connection to holiday light strands, such AC output unit being modulated synchronously to the music rhythm by the controller;
a housing unit to encapsulate the foregoing.
